(19) United States
(12) Patent Application Publication
(10) Pub. No.: US 2003/0055876 A1
(43) Pub. Date: Mar. 20, 2003

(54) Printing web content from self-service kiosks

(76) Inventors: Aravinda Korala, Edinburgh (GB); Christine Horsch, Edinburgh (GB)

Correspondence Address: SALTAMAR INNOVATIONS, 30 FERN LANE, SOUTH PORTLAND, ME, 04106, US

(21) Appl. No.: 09/943,626

(22) Filed: Aug. 29, 2001

(51) Int. Cl. G06F 15/16; G06F 17/60

(52) U.S. Cl. 709/203; 705/26

(57) ABSTRACT

A method of determining which frame or frames to print in a multiframe or multi-window self-service kiosk environment. A user need only make a simple selection in response to which one or more frames are rationally selected for printing. The frames to be printed are chosen depending for example on rules such as the URL of a web page or frame, on the presence of a meta-tag or selection is preformed by algorithms to decide which frames likely do not contain important information. Such algorithms are based on the frame location and dimensions within a browser window. There is also provided a method of printing on self-service kiosks comprising the step of using a browser or other renderer to write print information to a file, whereafter it can be printed using a self-service kiosk print module providing improved feedback to the control application. The method may also include the step of counting the number of pages after the markup language has been rendered and before it is sent to the self-service kiosk print module, thereby allowing charging a user for the number of pages printed.

### FIELD OF THE INVENTION

The present invention relates to the field of printing web content from self-service kiosks.

### BACKGROUND TO THE INVENTION

Self-service kiosks are computing devices placed in the public arena and designed to provide information, service or products to multiple users in separate self-contained sessions. Examples of kiosks are automatic teller machines (ATMs), public internet access terminals, credit card operated pre-paid ticket collection terminals, networked ticketing machines and computerised vending machines.

Many self-service kiosks display web content such as web pages written in a markup language such as HTML, DHTML, XHTML™ or XML. In the course of delivering web content, kiosks also run applications, including those downloaded across the internet in languages such as Java® or using component architectures such as ActiveX® or JavaBeans®. Typically, self-service kiosks that display web content have an internet connection for downloading the web content from remote servers. However, some or all of the web content they display can be stored locally, either within the self-service kiosk or in a commercial intranet or LAN.

The HTML 4 specification, available from the World Wide Web Consortium (www.w3.com) and other related markup languages, enable a browser window to be partitioned into multiple frames.

One common use of frames is to provide graphics and links in a first frame, which do not change when a new markup language document is retrieved and rendered in a second frame.

Furthermore, it is possible for a browser to display more than one window, each of which may consist of one or more frames. U.S. patent application Ser. Nos. 09/870,293 and 09/870,057 to Aravinda Korala, and to be assigned to Korala Associates Limited disclose a software architecture for enabling self-service kiosks to display a carefully laid-out web application using not only different windows implemented by a single browser component, but windows controlled by a plurality of browser components, each of which may display one or more browser windows. U.S. patent applications Ser. Nos. 09/870,293 and 09/870,057 are hereby incorporated by reference. The ability to operate linked web commerce applications in multiple frames and windows on screen enables many useful new types of web commerce transaction to be implemented.

However, in multiple frame and multiple browser window environments a problem is commonly faced when a user wishes to make a print instruction. It is desirable for users to be able to simply select a print command without having to qualify what they want to print, for example by having to choose options from a dialogue box. For this reason many browsers, such as Internet Explorer® 5.5 from Microsoft of Redmond, Wash., display a single icon which, when selected, causes the most recently selected frame to be printed. Options can be changed allowing the print icon to trigger printing of all frames. However, users often find that the frame which is printed is not that which they wanted or that, alternatively, more information is printed than they required. Internet Explorer® 5.5 does provide a user with the option to select printing of all windows or just the most recent window from a dialogue box displayed in response to the PRINT command on the FILE menu; however, this is not sufficiently flexible for all applications and is inappropriate on a self-service kiosk in the public arena where menus and dialogue boxes are typically suppressed. It is also not appropriate to give a user a choice when it is desired to print a frame which a user cannot see and does not know is present; for example, when a frame is rendered hidden behind another window and is intended for printing but not display.

Therefore, a first aim of the present invention is to enable an appropriate frame or frames to be printed in response to a simple user request to print.

Yet further problems are present when multiple windows are displayed on screen at once. By default in windowing environments such as Windows®, selecting PRINT in a browser window will cause the content of one or all frames in that window to be printed as discussed previously. However, there is no self-service kiosk known to us to have implemented a satisfactory method for enabling an appropriate frame and/or window or windows to be printed in response to a simple user request to print when multiple browser windows or multiple browser components are present.

The present invention therefore also aims to enable a simple user print instruction to be responded to appropriately in a multi-window, multi-frame environment on a self-service kiosk.

A further problem faced with printing from self-service kiosks relates to the particular printing features available in common operating systems used to operate self-service kiosks. At the present time most self-service kiosks use a standard operating system such as Windows NT® 4.0. Most self-service kiosks simply use Windows NT® basic printing feature; however, this has many limitations, particularly in terms of its ability to report printer status information to a controlling application. If the printer runs out of paper or breaks, the kiosk can detect if a print job fails, so it could for example go out of service. But the kiosk can't give detailed error reports to the controlling application. This makes it difficult to monitor the self-service kiosk from a remote location as official inspection is required to check printer status. Neither can the kiosk detect when the printer is running low of paper or ink, which would allow the kiosk owners sending out an operator to replenish the paper or ink before the printer fails. .

For printing HTML documents, typically the rendering will be done by the browser, such as the Internet Explorer® 5 browser component, available from Microsoft® of Redmond, Wash. The result of this rendering is a description of the document in the page layout format of the particular printer. This is then transmitted to the printer by the appropriate Windows printer driver. The Internet Explorer® 5 print method has some additional useful features, for example the ability to ignore background colour, making printing of coloured web pages more visible on black and white printers.

However, this method does not have the useful additional printing features provided in Windows Extensions for Financial Systems (XFS) available in the XFS specification available from http://www.xfsws.com. For example, XFS print commands provide paper, load, ink and toner low status information, notification of when printing has taken place, retraction of paper and more complex paper functions such as cutting, ejecting etc. However, these features are not used with self-service kiosks using Internet Explorer® 5.5 on a Windows NT® operating system.

A further problem is that printing from self-service kiosks is sometimes charged to the user per page and it is not immediately possible in Windows® or in Internet Explorer® 5.5 to calculate the number of pages which will be required to print an entire page or frame until the print operation has been completed. This makes it impractical to warn the user of the cost or prevent a job being started which exceeds the credit available to the user. Therefore, a further aim of the present invention is to provide new printing methods to obviate these problems.

### BRIEF DESCRIPTION OF THE INVENTION

According to a first aspect of the present invention there is provided a method of selecting images for printing on a self-service kiosk, the self-service kiosk having a web browser for rendering markup language documents and causing said rendered documents to be displayed on a screen, the self-service kiosk having the capacity to display a plurality of visual information in a plurality of frames, the contents of each frame being specified by a different markup language document, the method comprising the steps of:

receiving a print command from a user; and

selecting at least one frame for printing dependent on the URL of a displayed markup language document.

This means that a user of the self-service kiosk has only to make a simple print command and, without having to specify a particular frame or frames, receives a print-out which has been rationally chosen to consist of relevant selected frames.

In further aspects, one or more frames may be selected for printing dependent on information contained within a displayed markup language document, the location within a browser window or dimensions of one or more frames or the content of a markup language document.

According to a yet further aspect of the present invention there is provided a method of printing a markup language document on a self-service kiosk, the method comprising the steps of:

responsive to a print instruction, a markup language rendering module preparing an output print file containing raw printer data corresponding to said markup language document;

instructing a print module to print the raw printer data in the output print file.

This aspect enables a print module capable of providing printer status information, to be used to provide print output on the kiosk, whilst also benefiting from the rendering facilities of a markup language rendering module such as a web browser.

Preferably, the method further includes the step of counting the number of page breaks in the output print file and thereby determining a user's bill for printing. Preferably also, printing will not take place unless the user credit exceeds the printing charge. This counting of the number of page breaks in the output print file allows calculations and decisions to be made based on the number of pages a document will require to print even if that document is written in a markup language which does not list page breaks.

### DESCRIPTION OF THE SEVERAL DRAWINGS

An example embodiment of the present invention will now be illustrated with reference to the following Figures in which:

FIG. 1 is a schematic diagram of a self-service kiosk;

FIG. 2 is multi-frame browser window;

FIG. 3 is a self-service kiosk screen displaying multiple browser windows with multiple frames;

FIG. 4 is a flow diagram of the process of the present invention;

FIG. 5 is a block diagram of key components of self-service kiosk control software;

FIG. 6 is a flow diagram of a print method; and

FIG. 7 is a flow diagram of a print method including page counting.

### DETAILED DESCRIPTION OF THE PREFERRED EMBODIMENT

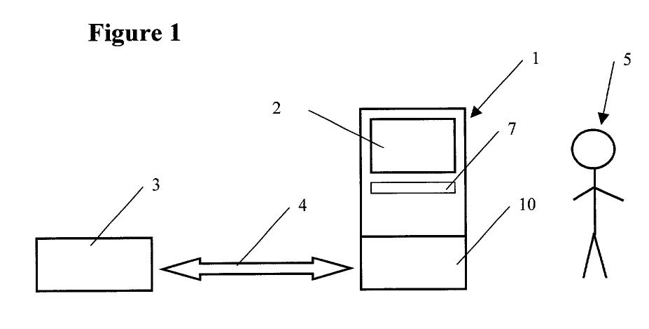

FIG. 1 illustrates a self-service kiosk 1 having a display 2 and having access to one or more servers 3 across a network 4. The network 4 is preferably the internet and servers 3 are preferably HTTP servers; however, other networking protocols or internal communications routes to locally stored information can readily be substituted.

Kiosks have user interfaces for interaction with users 5 and are controlled by a control computer 10. In the preferred embodiment, the control computer 10 runs Windows NT® 4.0 but those skilled in the art can select alternative operating system depending on commercial and programming preferences. User interfaces may incorporate devices such as monitors, touch screens, keyboards, mice, cash dispensers, card reading devices, identification devices such as number pads for inputting in a PIN number or iris, retina or finger print readers. The self-service kiosk 1 has a printer 7 which is used to provide a hard copy of information. Typically, the information printed will be a copy of information shown on display 2 within a browser window; however, other information which has not been displayed will commonly be output, for example a confidential bank statement.

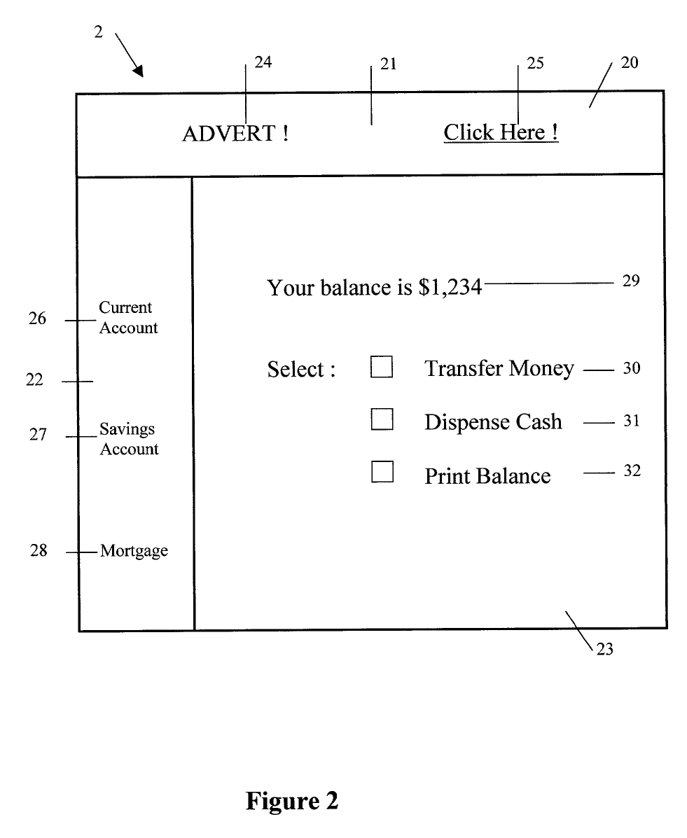

FIG. 2 shows a web browser window 20 that occupies the whole of a display 2. Browser window 20 comprising three separate frames 21, 22 and 23. Individual frames 21, 22 and 23 are rendered from separate markup language documents and present different information. Preferably, frame display documents are rendered by a web browser and written in a markup language such as HTML, DHTML, XHTML™ or XML.

In this example, frame 21 is an advert comprising advertising matter 24 and a link 25 to an external advert. If a user clicks on the link 25, a separate browser window appears showing an advert, as is well known in web advertising. A control frame 22 provides links to various different features pertaining to the service being provided to the user of the self-service kiosk. Here, the self-service kiosk 1 is delivering a banking application and a user can display web pages relating to specific accounts by selecting links referring to their current account 26, savings account 27 or mortgage 28. Clicking on a link 26, 27 or 28 causes a web browser 120 to download and render a different web page in central frame 23 depending on the link selected.

In the present example main frame 23 displays a user's account balance 29, options enabling a user to transfer money 30 or dispense cash 31 and a print option 32, which, if selected, will print a user's balance. If a user wants to print their balance, it is inappropriate to print either the entire display 2, the advert in frame 21 or control information in frame 22. It is most appropriate to print the main frame 23 or, alternatively, a separate document not as yet displayed summarising their account balance.

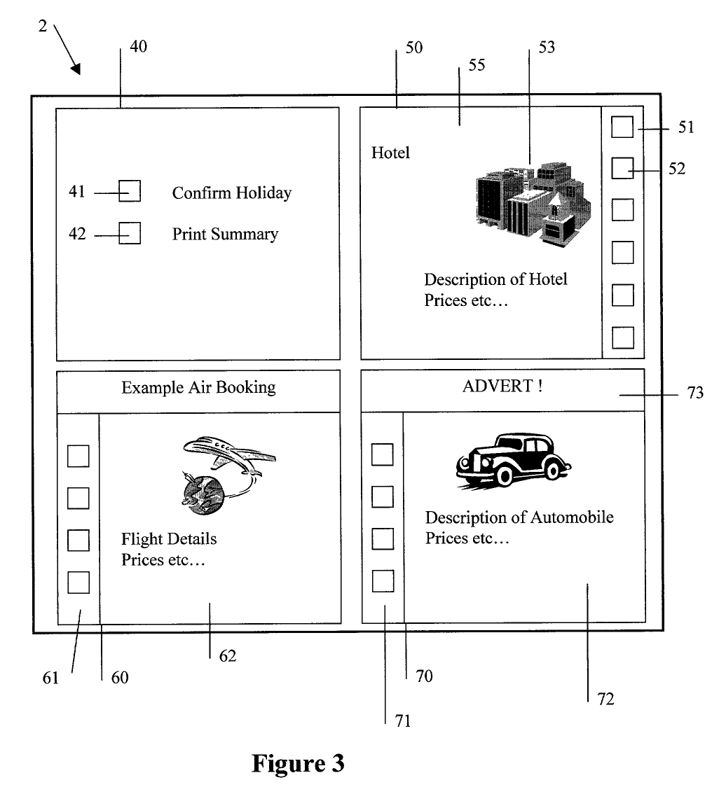

FIG. 3 illustrates another example where a user is presented with several different browser windows 40, 50, 60 and 70 on screen 2. These may be implemented by separate browser components or can be multiple windows controlled by a single browser component. Alternatively, the whole structure can be provided using a complex arrangement of frames in a single browser window. Preferably, separate windows 40, 50, 60 and 70 are provided. Control window 40 provides a central menu enabling a user 5 to book a holiday.

Hotel booking window 50 enables a user to select a hotel. Link frame 51 contains different icons for different hotels and as a user selects different icons 52 from link frame 51, different hotel pictures 53 and additional information about the selected hotel 54 are shown in the main frame 55 of window 50.

A separate flight booking window 60 enables a user 5 to select flights for a holiday. Flights provided by different carriers can be selected from a menu provided in link frame 61 and information for a particular airline is displayed in frame 62. Conventional on-line air flight booking technology enables a user to select and display information about a flight.

Car booking window 70 enables a user to book car hire, selecting different models to view from link frame 71 which determines which set of information is displayed in frame 72. Additional advertising is shown in frame 73. The use of multiple browser windows enables a user 5 to interact separately with hotel, car and flight booking applications.

Control window 40 presents a user with options including confirming the holiday 41 or printed a summary of a holiday that they designed by selecting a hotel, flights and a car in the other windows. A user may only confirm the holiday when appropriate hotels, flights and car hire have been selected. However, if a user selects print summary 42 by selecting the print summary button 42, the summary that is printed should not be any one of the browser windows, nor indeed the whole screen 2. In the present example, individual frames would be selected and displayed, for example frame 55, frame 62 and frame 72 are printed in turn. A separate HTML document is prepared in a hidden window (not shown) containing frames 55, 62 and 72 and then printed after information that has not been shown on screen has been added to it.

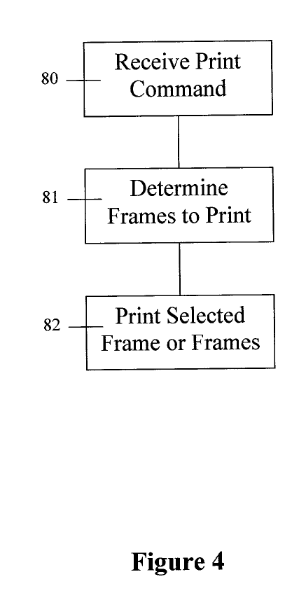

FIG. 4 is a flow chart illustrating the print process of the present invention. Initially, a print command is received from a user 80 or from an application. Thereafter, print handling module 110 determines which frames to print 81 and then causes said selected frames to be printed 82. This can be done by traversing the Document Object Model (DOM) of the document until the correct frame is found, and then passing this to the Windows Object Linking and Embedding (OLE) Application Programming Interface (API) command “Exec” with the parameter OLECMDID_PRINT.

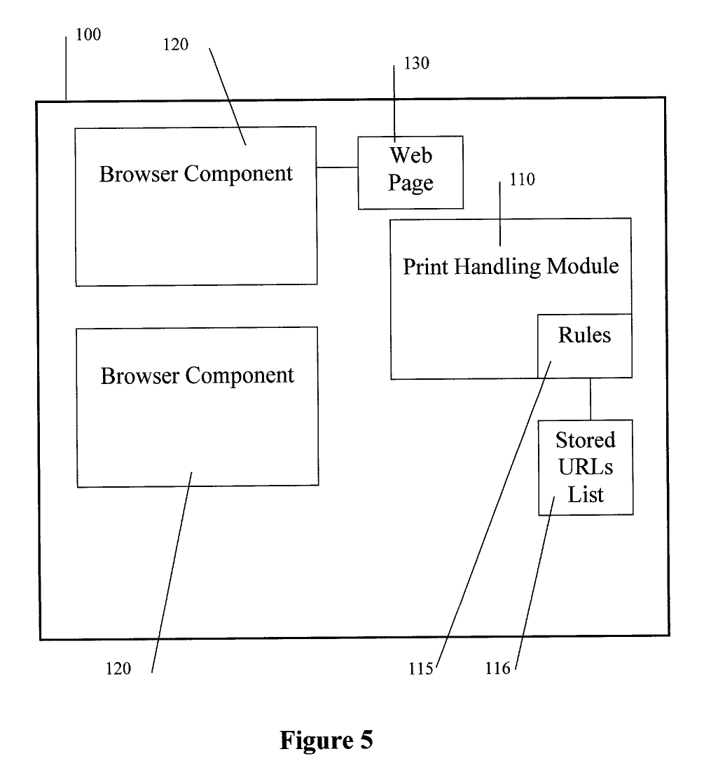

FIG. 5 shows in schematic form the software architecture of the preferred embodiment of the present invention. A container application 100 comprises a print handling module 110 and one or more browser components 120 for downloading and displaying web pages 130. Each browser component 120 may render the contents of more than one browser window and each window may have one or more frames. Preferably, rules 115 are provided for determining whether a page should be printed.

The print procedure can be initialised in different ways. Preferably, a print command will be generated in response to a user selecting an icon 42 in a displayed web page which generates an event and the print handling module 110 is responsive to that event. A web page written in a language such as HMTL, DHTML, XHTML™ or XML™ can call a software method responsive to the event. In this embodiment, a web page 130 has been retrieved by a browser 120 and specifies a user interface including a visual element which, when selected, calls the software method print handling module 110.

A print command may also be generated by a user pressing a dedicated button on a self-service keyboard, by clicking on a ‘print’ button in a separate area of the screen from the browser windows, or automatically by an application. For example, an application running on the self-service kiosk may directly call print handling module 110.

Thereafter, print handling module 110 determines 81 which frame or frames should be printed. Preferably, this is dependent on one or more print determining rules 115. Print determining rules may be provided as program code or simply stated in a file which is parsed and interpreted by the print handling module 110.

Print determining rules 115 may include rules conditional on the URL of a web page. For instance, when a print handling module 110 is called by a particular web page 130, the print handling module 110 may compare a URL with a stored list of URLs 116 defined individual URLs or sets of URLs and lists which frame should be printed for each URL specified in the rules.

In a further sophistication, rules 115 may take into accounts the URLs of individual frames. For example, rules may specify that certain information at certain URLs should be printed if those URLs are displayed in any frame.

Rules 115 may also be conditional on information contained in web pages, for example web pages may contain meta tags associated with this print feature. Print handling module 110 can be readily adapted to search through each web page currently being displayed for all documents comprising the meta tag and then print each frame containing the meta tag.

Rules 115 may also be conditional on the location of a frame on screen, for example in the case of FIG. 2, frame 21 covers the entire width of the screen and is wider than it is tall. This location and height to width ratio are commonly associated with adverts which preferably would not be printed. Similarly narrow windows on the left hand side of the screen are also often not appropriate to print 22. In this case, rules 115 can specify algorithms identifying inappropriate frame by their location and dimensions. In this case, the location and height to width ratio of frames 21 and 22 indicated that the only other frame, 23, should be printed.

As a result, a user can activate a simple print command without having to make a complex selection from a dialogue box and without having to choose from several different print options. The resulting hard copy is rationally chosen to be appropriate to the web commerce application that users have been using.

In a further embodiment there are provided sets of rules in a format referred to herein as sitesets. Sitesets specify information relating to individual services provided on a self service kiosk. For example, one siteset may define information pertaining to the banking application shown in FIG. 2. A siteset preferably defines one or more URLs of initial web pages to display when a particular self-service kiosk function is selected. Sitesets may also specify URLs which a user should not be allowed to access. Sitesets may specify the location and dimensions of browser windows 40, 50, 60 and 70 on the display and may additionally specify a URL of a web page to which the self-service kiosk should revert at the end of a session with an individual user. Further information about sitesets is provided in U.S. application Ser. No. 09/870,057 to Aravinda Korala, and to be assigned to Korala Associates Limited and incorporated herein by way of this reference.

In a further embodiment of the present invention there are provided one or more selectable agent software applications, each may be activated or de-activated in response to a user selection. An individual site agent defines functionality which is called when individual web pages 130 are downloaded by browser modules 120. Site agent modules may for example, send instructions to peripheral devices to carry out particular functions, they might send instructions to and receive information from web pages, site agents receive events whenever web pages 130 are downloaded whilst they are activated. The print handling module 110 may be part of the site agent, so that the site agent contains the logic for determining which frame or frames are to be printed. Further information about site agents is provided in U.S. application Ser. No. 09/870,293 in the name of Aravinda Korala, to be assigned to Korala Associates Limited.

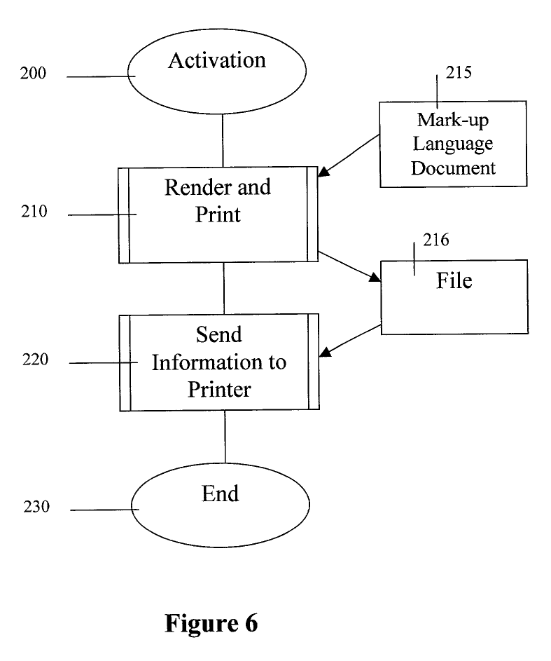

The invention further provides an improved method of printing on a self-service kiosk once the particular markup language documents to be printed have been established. FIG. 6 is a flow chart of a printing method. The method begins 200 when the frame, frames or other information to be printed have been determined. Firstly, a web browser 120 is instructed to render and print 210 a mark-up language document 215 to a file 216. This may be carried out by passing this frame, frames or other information to a browser component such as Microsoft® Internet Explorer® using the Windows OLE API command “Exec” with the parameter OLECMDID_PRINT.

Internet Explorer® browser component outputs raw printer data to file 216. Thereafter the information is sent 220 to the printer using a self-service kiosk print module. Preferably, the self-service print module is Kalignite® KXStatementPrinter ActiveX® control available from Korala Associated Limited of Edinburgh, Scotland or is Kalignite® KXStatementPrinter Javabean available from Korala Associated Limited of Edinburgh, Scotland or is an OPOS™ print control object such as the OPOS 1.6 Printer common control object available Monroe Consulting Services, Dayton, Ohio, XFS printer service provider such as Data Techno BDT service provider available from Korala Associated Limited of Edinburgh, Scotland or JXFS comjxfs.service.IjxfsPrinterService Java class available from IBM of White Plains, N.Y. Each of these modules provides control over self-service features such as stacking and ejecting printout and capturing untaken printout. Each of these modules also provides status information such as low paper that exceeds the status information available from the standard facility provided by Windows NT 4.0®.

In one embodiment, data 216 for sending to a printer is raw printer data in appropriate format such as Postscript®. In an alternative embodiment the browser is instructed to output data 216 in the form of a bit map. A bit map can then be embedded into a XFS form which contains a single field of type bit map. This form is then printed by the XFS print control.

In a further alternative embodiment a container application implements its own renderer which converts HTML into the XFS form language not as a bit map but as a series of appropriate fields (text, graphics, bit map etc) for insertion into a form. Importantly, this means that rendered information from an HTML document or other similar mark-up language document, such as DHTML, XHTML™ or XML can then be printed using XFS.

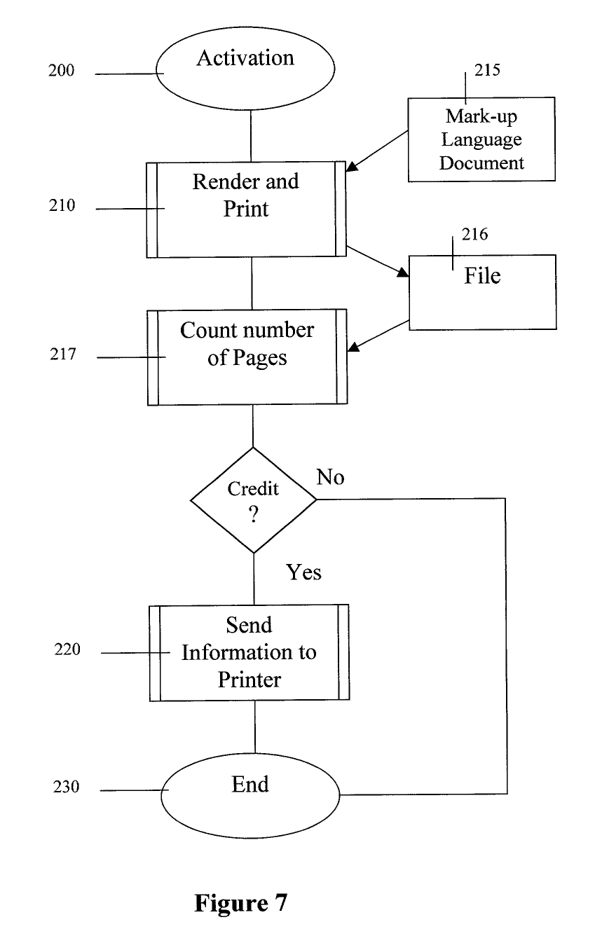

FIG. 7 illustrates a preferred embodiment including the additional step of counting 217 the number of pages in data file 216. This is now possible because raw printer data will comprise page breaks which can be readily identified by scanning through data file 216. Page breaks are, however, not provided in the initial mark-up language document 215 and so the number of pages could not be correctly determined before rendering 210. After counting the number of pages, a decision 208 can then be made as to whether or not to allow printing the document. For example, the cost of printing the required number of pages can be compared to the amount of credit a user has in which case the procedure either continues 220 or is alternatively cancelled if insufficient credit remains. Even if there is no set credit limit, counting the number of pages 217 enables a user to be billed appropriately depending on the number of pages that have been printed. Alternatively the kiosk could display the cost to the user and display a message asking the user to confirm the print request. This method can also help track the number of sheets of paper left in the self-service kiosk 1.

This method therefore allows the benefits of a web browser mark-up language renderer to be combined with the improved feedback provided in self-service kiosk print controls.

The invention extends to computer programs in the form of source code, object code, code intermediate sources and object code (such as in a partially compiled form), or in any other form suitable for use in the implementation of the invention. Computer programs may be standalone applications, software components, scripts or plug-ins to other applications. Computer programs embedding the invention may be embodied on a carrier, being any entity or device capable of carrying the computer program: for example, a storage medium such as ROM or RAM, optical recording media such as CD-ROM or magnetic recording media such as floppy discs. The carrier may be a transmissible carrier such as an electrical or optical signal conveyed by electrical or optical cable, or by radio or other means. Computer programs may be provided for download across the internet from a server. Computer programs may also be embedded in an integrated circuit. Any and all such embodiments containing code that will cause a computer to perform substantially the invention principles as described, will fall within the scope of the invention.

Further modifications and alterations can be made within the scope of the invention herein disclosed.

What is claimed is:

1. A method of selecting images for printing on a self-service kiosk, the self-service kiosk having a web browser for rendering markup language documents and causing said rendered documents to be displayed on a screen, the self-service kiosk having the capacity to display a plurality of visual information in a plurality of frames, the contents of each frame being specified by a different markup language document, the method comprising the steps of:
receiving a print command from a user; and
selecting at least one frame for printing, the selection depending on the URL of a displayed markup language document.

2. The method of claim 1 further comprising the step of a user making a print command by selecting an image on screen, said image being defined by a markup language document which further defines an event to be generated when said image is selected.

3. The method of claim 1 further comprising the step of a user making a print command by selecting an image on a screen, said image being defined by a control application, said control application further defining an event to be generated when said image is selected.

4. A method of selecting images for printing on a self-service kiosk, the self-service kiosk having a web browser for rendering markup language documents and causing said rendered documents to be displayed on a screen, the self-service kiosk having the capacity to display a plurality of visual information in a plurality of frames, the contents of each frame being specified by a different markup language document, the method comprising the steps of:
receiving a print command from a user; and
selecting one or more frames for printing dependent on information contained within a displayed markup language document.

5. The method of claim 4 wherein said information contained within a displayed markup language document comprises a metatag.

6. A method of selecting images for printing on a self-service kiosk, the self-service kiosk having a web browser for rendering markup language documents and causing said rendered documents to be displayed on a screen, the self-service kiosk having the capacity to display a plurality of visual information in a plurality of frames, the contents of each frame being specified by a different markup language document, the method comprising the steps of:
receiving a print command from a user; and
selecting one or more frames for printing dependent on the location within a browser window or dimensions of one or more frames.

7. The method of claim 6 wherein said selection excludes frames displayed at the top of a window.

8. The method of claim 6 wherein said selection excludes frames displayed at the top of a window and which are wider than they are high.

9. The method of claim 6 wherein said selection excludes frames displayed at one side of a window, said one side being selected from a list comprising the left side and the right side.

10. The method of claim 6 wherein said selection excludes frames displayed at said one side of a window and which are higher than they are wide.

11. A method of selecting images for printing on a self-service kiosk, the self-service kiosk having a web browser for rendering markup language documents and causing said rendered documents to be displayed on a screen, the self-service kiosk having the capacity to display a plurality of visual information in a plurality of frames, the contents of each frame being specified by a different markup language document, the method comprising the steps of:
receiving a print command from a user; and
responsive to said print command calling a software agent module which causes one or more frames to be printed, said software agent module being activatable in response to previous user actions and said software agent module only being called when it has been previously activated in response to a user selection of a service related to at least one of said plurality of frames.

12. A method of printing a markup language document on a self-service kiosk, the method comprising the steps of:
responsive to a print instruction, a markup language rendering module preparing an output print file containing raw printer data corresponding to said markup language document;
instructing a print module to print the raw printer data in the output print file.

13. The method of claim 12 wherein the print module is selected from a group consisting of: an XFS component, a J/XFS component, a Kalignite print component, an OPOS print component and an ActiveXFS print component.

14. The method of claim 12 further comprising the step of counting the number of pages in the output print file and thereby determining a bill for a user.

15. The method of claim 12 further comprising the step of counting the number of pages in the output print file and thereby determining whether or not to print said pages.

16. The method of claim 14 further comprising the step of displaying the bill to the user and asking the user to confirm whether or not to print said pages.

17. A computer program comprising program code which, when executed, causes said computer to perform the method of claim 1.

18. A computer program comprising program code which, when executed, causes said computer to perform the method of claim 12.
